(19) United States
(12) Patent Application Publication
(10) Pub. No.: US 2011/0204203 A1
(43) Pub. Date: Aug. 25, 2011

(54) STEERABLE VEHICLE LIGHTING SYSTEM

(76) Inventor: Douglas C. Miller, Severna Park, MD (US)

(21) Appl. No.: 12/711,143

(22) Filed: Feb. 23, 2010

(51) Int. Cl. F16M 11/08; F16M 13/02

(52) U.S. Cl. 248/550; 248/349.1; 74/63

(57) ABSTRACT

A steerable vehicle lighting system includes a steerable platform assembly and a control assembly. The steerable platform assembly has a body adapted to be mounted to a vehicle, a platform adapted to receive a payload and adapted to rotate with respect to the body, an actuator at least partially placed in the body, and an actuator rod rotatably mated to the actuator and rotatably mated to the platform. A rotation of the actuator rotates the platform. The control assembly includes a first wheel adapted to be placed on a rotating portion of a steering apparatus, a transducer adapted to be mated to a stationary portion of the steering apparatus, a second wheel mated to a rotatable portion of the transducer and adapted to be rotated by the first wheel, and an elastic member that elastically urges the transducer and the second wheel towards the first wheel.

### FIELD OF THE INVENTION

The present invention relates to a lighting system. In particular, the present invention relates to a lighting system that can be steered by a steering apparatus of a vehicle.

### BACKGROUND OF THE INVENTION

When operating an automobile during low ambient light conditions, the path of the automobile is illuminated by the automobile's installed lights. Typically, automobiles are installed with two forward headlamps and a reversing illumination system at the rear. Both of these installed lights are fixed in their direction of illumination, and thus provide insufficient lighting for areas peripheral to the illumination direction. However, an operator of the automobile may need illumination for these peripheral areas, for example, when driving on curved roads or when maneuvering in treacherous terrain.

Preferably, the light should be steerable with the installed steering apparatus of the automobile. However, known steerable lighting systems require precise measurement of the number of turns of the steering apparatus from lock to lock, i.e., from full right steer to full left steer. The number of turns from lock to lock varies with particular models of automobiles. Thus, manufacturing and installation of such systems are overly complex and difficult. Also, other known steerable lighting systems include gears driven by the steering apparatus. However, gears need to be precisely aligned during installation. Furthermore, the gears need to be disassembled to adjust the turning of the lights with the turning of the steering apparatus. Additionally, gears require some tolerance between their intermeshing teeth, and the tolerance increases as the intermeshing teeth become worn. Moreover, gears can introduce imprecise measurement of the steering apparatus because of these tolerances or backlash. Finally, debris can become trapped between gears causing them to seize and potentially result in catastrophic steering failure.

Thus, there is a need in the art for a lighting system that is steerable by the steering apparatus of an automobile. The lighting system should be able to precisely measure the movement of the steering apparatus and be relatively simple to manufacture and install. Also, the lighting system should be easily adjustable without requiring substantial disassembly. In addition, the failure of the lighting system should not cause catastrophic steering failure.

### SUMMARY OF THE INVENTION

Accordingly, one aspect of the invention may provide a steerable platform assembly that includes a body adapted to be mounted to a vehicle, a platform placed substantially within the body, an actuator at least partially placed in the body, and an actuator rod with an adjustable length that is rotatably mated to the actuator and rotatably mated to the platform. The platform is adapted to receive a payload and adapted to rotate with respect to the body, thus a rotation of the actuator rotates the platform.

Another aspect of the invention may provide a control assembly that includes a first wheel adapted to be placed on a rotating portion of a steering apparatus and rotatable with the rotating portion of the steering apparatus, a transducer with a rotatable portion adapted to be mated to a stationary portion of the steering apparatus, a second wheel mated to the rotatable portion and adapted to be rotated by the first wheel, and an elastic member that elastically urges the transducer and the second wheel towards the first wheel.

Yet another aspect of the invention may provide a steerable system that includes a steerable platform assembly and a control assembly. The steerable platform assembly has a body adapted to be mounted to a vehicle, a platform placed substantially within the body, an actuator mounted in the body, and an actuator rod with an adjustable length that is rotatably mated to the actuator and rotatably mated to the platform. The platform is adapted to receive a payload and adapted to rotate with respect to the body, thus a rotation of the actuator rotates the platform. The control assembly includes a first wheel adapted to be placed on a steering shaft and rotatable with the steering shaft, a potentiometer with a rotatable portion and adapted to be coupled to a stationary portion of the vehicle, a second wheel mated to the rotatable portion and adapted to be rotated by the first wheel, and an elastic member that elastically urges the potentiometer and the second wheel towards the first wheel. The potentiometer is in communication with the actuator, and a rotation of a steering wheel causes rotation of the steering shaft, the first wheel, the second wheel, and the rotatable portion of the potentiometer. The rotation of the rotatable portion changes a resistance value of the potentiometer and the actuator rotates in response.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of a vehicle with a lighting system in accordance with an embodiment of the invention;

FIG. 2 is a front perspective view of a steerable platform assembly of the lighting system shown in FIG. 1;

FIG. 3 is a bottom plan view of the steerable platform assembly shown in FIG. 2;

FIG. 4 is a bottom perspective view of the steerable platform assembly shown in FIG. 2;

FIG. 5 is a front perspective view of the steerable platform assembly shown in FIG. 2 without a body;

FIG. 6 is a perspective view of a control assembly of the lighting system shown in FIG. 1; and

FIG. 7 is a perspective view of a control assembly of the lighting system shown in FIG. 1.

### DETAILED DESCRIPTION OF THE INVENTION

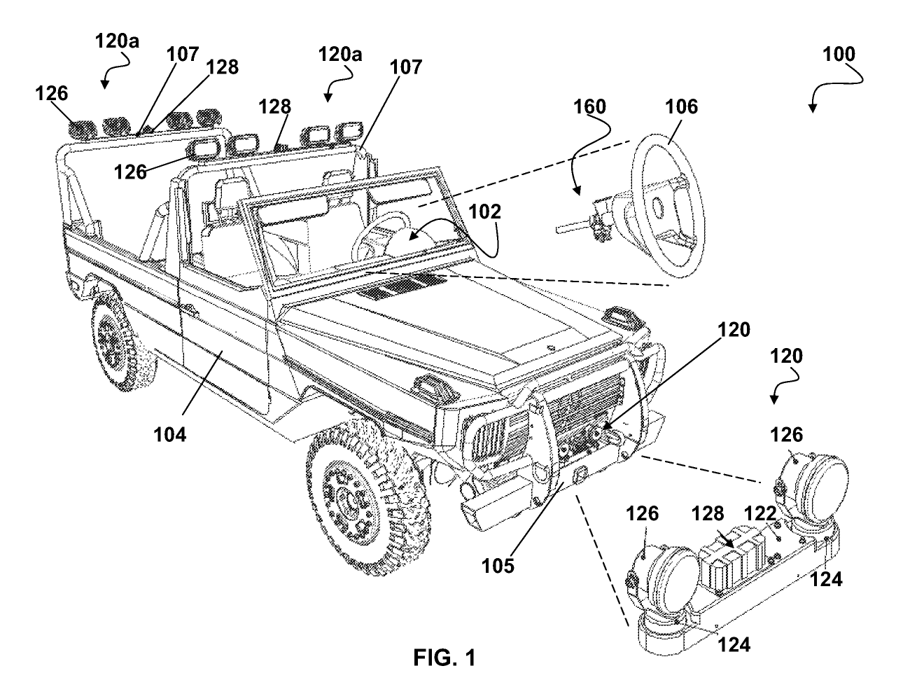

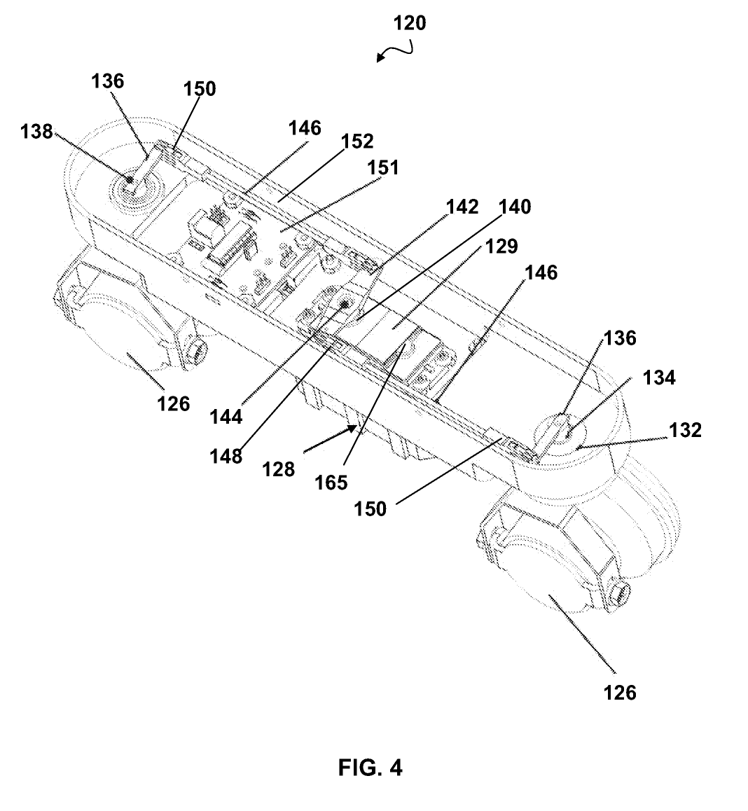

Referring to FIGS. 1-7, the present invention provides a lighting system 100 that can be controlled through the installed steering apparatus 102 of a vehicle 104. The lighting system 100 can precisely measure the movement of the steering apparatus 102 and is relatively simple to manufacture, install, and adjust. Also, the failure of the lighting system 100 does not cause jamming or catastrophic failure of the steering apparatus 102. Furthermore, the lighting system 100 can be installed in addition to the preinstalled lights of the vehicle 104 so that the preinstalled lights provide illumination in the forward or rear directions, while the lighting system 100 can provide illumination for areas other than the forward or rear direction.

Turning to FIG. 1, the lighting system 100 includes a steerable platform assembly 120 and a control assembly 160 for forming and transmitting control signals to the steerable platform assembly 120. As shown in the figure, the steerable platform assembly 120 can be mounted to one or more parts of the vehicle 104, such as the steerable platform assembly 120 that can be mounted to a brush guard 105 or another embodiment of the steerable platform assembly 120a that can be mounted to a roll bar 107.

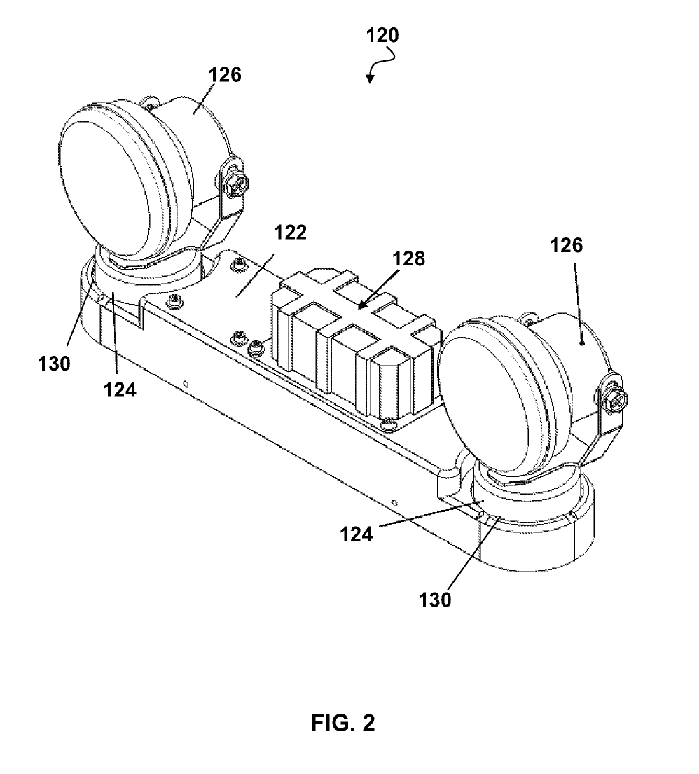

Referring to FIG. 2, the steerable platform assembly 120 includes a body 122, and at least one steerable platform 124 disposed substantially in, on, or adjacent to the body 122. In some embodiments, the body 122 and the steerable platform 124 may be combined into one integral construction. The body 122 provides a base for the steerable platform 124. Thus, the steerable platform 124 can move away from the body 122, move towards the body 122, rotate with respect to the body 122, roll with respect to the body 122, some combination of the aforementioned, or some other movement required for a particular application of the lighting system 100. The body 122 can also include couplings adapted to mate with the vehicle 104 or be configured to be mated to the vehicle 104. In other embodiments, the body 122 may be integral with the chassis of the vehicle 104 or some other part of the vehicle 104. The body 122 can be made from a generally rigid material, such as, but not limited to, metal, metal alloys, plastic, wood, ceramic, glass, some combination of the aforementioned, or some other substantially rigid material. The body 122 can have any shape that provides a suitable base for the steerable platform 124 or that supports the steerable platform 124.

In the embodiment shown in FIGS. 2-5, the steerable platform assembly 120 has a generally elongated body 122 with two steerable platforms 124. However, the number of steerable platforms 124 is not meant to be limiting. In other embodiments, the steerable platform assembly 120 can have more or less than the two steerable platforms 124 shown. The exact number of steerable platforms 124 is determined by, for example, the size of the body 122, where the steerable platform assembly 120 will be mated to the vehicle, the number of steerable platforms 124 required, and the like. The body 122 of the depicted embodiment can be made from plastic, aluminum, or steel.

The steerable platform 124 provides a movable base for a payload 126. The payload 126 may be disposed substantially in, on, or adjacent to the steerable platform 124. The payload 126 may also have its own movement system such that the payload 126 provides a movement or motion in addition to that of the steerable platform 124. The steerable platform 124 can be shaped to mate with or support the payload 126. Thus, the steerable platform 124 can have a generally planar surface or a surface shaped to mate or interlock with the payload 126. Also, the steerable platform 124 can have a substantially cylindrical, spherical, polyhedral, some combination of the aforementioned, or some other shape suitable for providing a base or support to the payload 126. The steerable platform 124 may also include a coupling to couple the steerable platform 124 to the payload 126, such as interlocking mechanical parts that can include threaded fittings, pressure fittings, friction fittings, rivets, screws and nuts, or some other interlocking mechanical parts; bands or belts that encompass the steerable platform 124 and the payload 126; adhesives; some combination of the aforementioned; or some other coupling that can mate the steerable platform 124 to the payload 126. The steerable platform 124 can be made from a generally rigid material, such as, but not limited to, metal, metal alloys, plastic, wood, ceramic, glass, some combination of the aforementioned, or some other substantially rigid material.

In the embodiment shown in FIGS. 2-5, the steerable platforms 124 have a generally cylindrical shape and are disposed in wells 130 formed at distal opposite ends of the body 122. The wells 130 are also substantially cylindrically shaped to receive the steerable platforms 124. The steerable platforms 124 of the depicted embodiment are made from either plastic, aluminum, or steel.

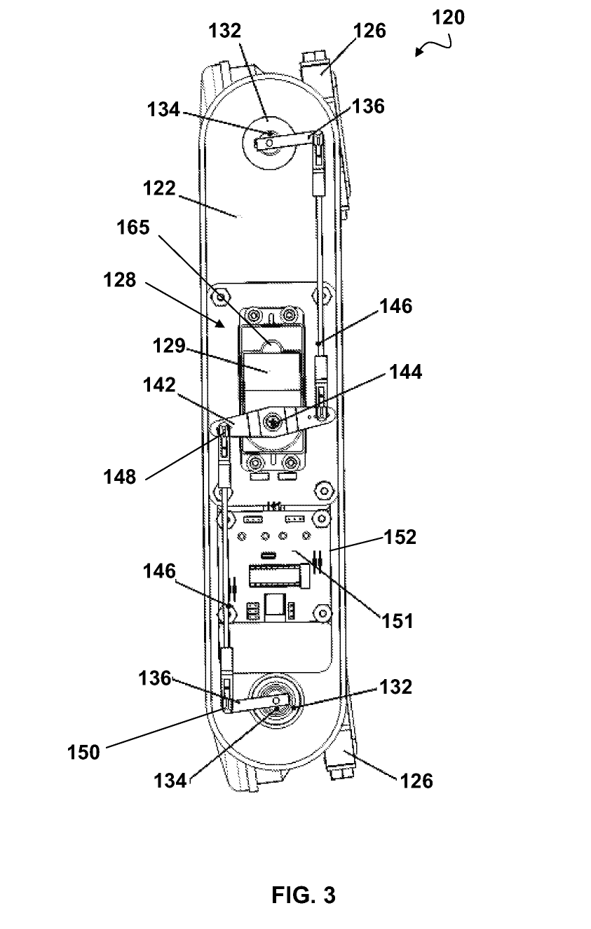

As best shown in FIGS. 3-5, the steerable platforms 124 are mounted on a roller bearing 132. The roller bearings 132 provide axial stability to the steerable platform 124. Also, each steerable platform 124 has an extending member 134 that extends substantially parallel to an axis about which the steerable platform 124 rotates. The extending member 134 is disposed near the center of the steerable platform 124 and extends substantially through the roller bearing 132. An arm 136 is fixedly coupled to a distal end 138 of the extending member 134 and extends generally orthogonally to the extending member 134.

The steerable platform assembly 120 can also include an actuator 128. The actuator 128 can transform a control signal into an electrical signal, electro-mechanical signal, mechanical signal, or mechanical movement that causes the steerable platform 124 to move away or towards the body 122, rotate, elevate, lower, roll, decline, incline, extend, retract, some combination of these movements, or some other movement or motion.

In the embodiment shown, the actuator 128 is a servo 129 that receives an electrical signal which causes the servo 129 to rotate an output shaft 140. A rotation of the output shaft 140 causes a rotation of the steerable platforms 124. In the depicted embodiment, the output shaft 140 is generally parallel to the extending members 134 of the steerable platforms 124. An appendage 142 is fixedly coupled substantially near or at a distal end 144 of the output shaft 140. The appendage 142 is mechanically coupled to each arm 136 of the steerable platforms 124. In the depicted embodiment, an actuator rod 146 is rotatably coupled to the appendage 142 at one end 148 and rotatably coupled to one of the arms 136 at an opposite end 150, and the length of the actuator rod 146 can be adjusted to substantially reduce any free play or other undesired excess movement between the appendage 142 and the arm 136. Thus, when the servo 129 rotates the output shaft 140, the output shaft 140 rotates the appendage 142, and as the appendage 142 rotates, the actuator rod 146 moves towards or away from the steerable platforms 124, and the arm 136 rotates. When the arm 136 rotates, the arm 136 causes the extending member 134 to rotate which causes the steerable platform 124 to rotate. Thus, the rotation of the steerable platform 124 causes the payload 126 to rotate.

In other embodiments, the actuator 128 can move the steerable platform 124 by one or more gears or gear trains, a rack and a corresponding pinion, a gear and a chain, a pulley and a belt, a signal transmitter and a motor that receives the signal, hydraulics, or any other mechanical, electrical, or electro-mechanical coupling that transfers the movement of the actuator 128 to the steerable platform 124. However, the selected coupling between the actuator 128 and the steerable platform 124 should minimize the free play between the actuator 128 and the steerable platform 124. As the vehicle 104 travels, shock, vibration, or some other movement can cause significant movement of the steerable platform 124 which can be distracting for a driver when a lamp is disposed on the steerable platform 124. The slight movement of the lamp can be amplified over the path of illumination into large swings of the light emitted by the lamp.

Also, the payload 126 shown is a commercially available lamp that emits visible light that has threads that mate with corresponding threads of the steerable platform 124. In other embodiments, the payload 126 can be a camera system that can accurately record a vehicle's traveled path, thermal cameras that highlight potential collision hazards, tactical countermeasures that can be directed for maximum effectiveness, an infrared emitter, a radar emitter and receiver, a satellite antenna, a weapon, or any other payload 126 that needs to be steered.

In the depicted embodiment, the actuator 128 is disposed between the steerable platforms 124. In other embodiment, the actuator 128 can be generally next to, in front of, behind, above, or below one of the steerable platforms 124. A portion of the actuator 128 is mounted on the body 122 and another portion 151, such as an electronic control card for a servo 129, is disposed within a hollow 152 of the body 122. In the embodiment shown in FIGS. 3-5, a housing for the servo 129 is mounted on the body 122, while the relatively more fragile and sensitive electronic components, such as a servo control board, are disposed within the body 122, such that the body 122 protects these components.

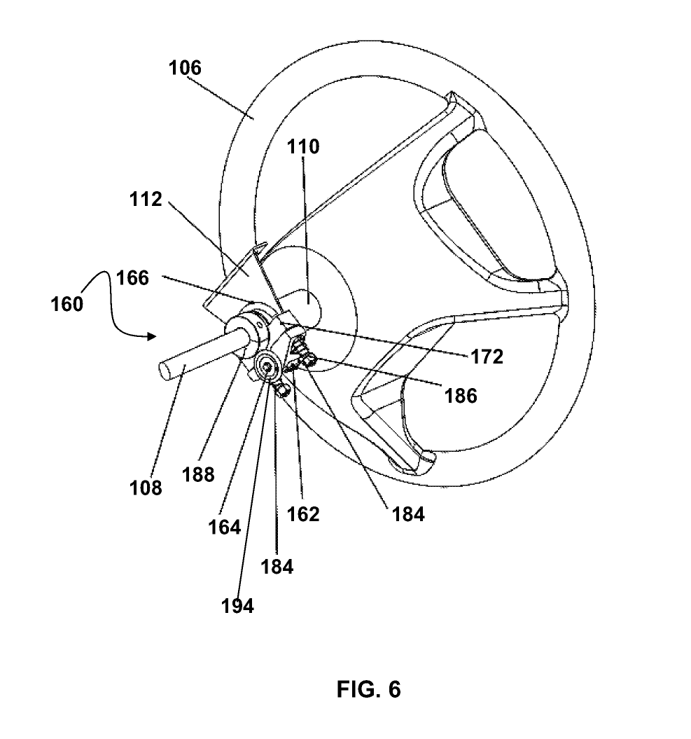

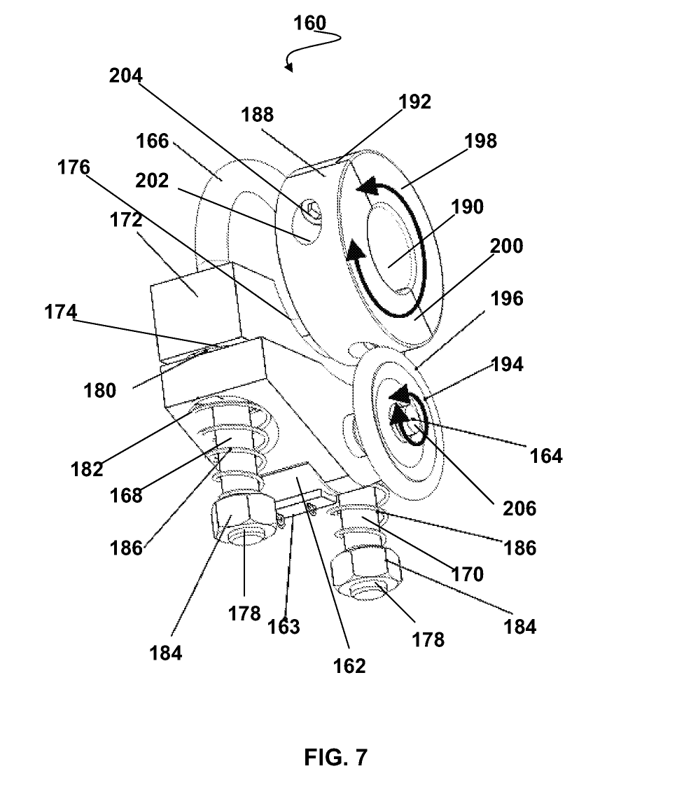

The actuator 128 receives a signal from the control assembly 160. Referring to FIGS. 6-7, the control assembly 160 includes a transducer 162 that transforms a movement of the steering apparatus 102 into an electrical control signal that causes the steerable platform 124 to move. The steering apparatus 102 includes a steering wheel 106 that is rotated by the operator of the vehicle 104, a steering shaft 108 that is fixedly coupled to the steering wheel 106 so that it rotates with the steering wheel 106, and a steering column 110 that partially encompasses the steering shaft 108 and does not rotate with the steering shaft 108. The steering apparatus 102 may be mounted to a bulkhead 112 of the vehicle 104. The transducer 162 is coupled to a stationary portion of the steering apparatus 102 or the bulkhead 112, but receives an input from a moving portion of the steering apparatus 102. In the embodiment shown, the transducer 162 is coupled to the stationary steering column 110 or the bulkhead 112 of the vehicle 104 and is rotated by the steering shaft 108.

Because the steering apparatus 102 includes a steering wheel 106 and a steering shaft 108 that rotates, the transducer 162 preferably transforms a rotational motion of the steering apparatus 102 into a signal that causes the steerable platform 124 to move. Thus, the transducer 162 can have a rotatable portion 164 that is driven by a rotational motion of the steering apparatus 102. In the embodiment shown, the transducer 162 is a potentiometer 163 with a rotatable portion 164, so that as the rotatable portion 164 rotates, the potentiometer 163 provides an increasing or decreasing electrical resistance value, so that when the potentiometer 163 is energized, the increasing or decreasing resistance value can provide an increasing or decreasing current, voltage, or some other electrical signal that can be transmitted, for example, to the actuator 128 of the steerable platform assembly 120.

The particular type of potentiometer 163 can be selected based on the intended application. For example, for a snow mobile or an all terrain vehicle, a potentiometer 163 with a single turn rotatable portion 164 can be used, but for a commercial vehicle, a potentiometer 163 with a five turn rotatable portion 164 is preferred. For fork lifts or similar plant equipment with significantly more turns between the locks of the steering wheel 106, a potentiometer 163 with a ten turn rotatable portion 164 can be used. One turn, five turn, and ten turn potentiometers 163 are readily available commercially. When selecting a particular potentiometer 163 for a particular application, the maximum number of turns of the potentiometer 163 should be as close as possible to the maximum number of turns of the intended vehicle's steering wheel 106, thus reducing the overall dimensions of the control assembly 160.

The potentiometer 163 can be coupled to a stationary portion of the steering apparatus 102, such as the steering column 110 or the bulkhead 112, while the rotatable portion 164 is driven by a rotating portion of the steering apparatus 102. Thus, a rotation of either the steering wheel 106 or the steering shaft 108 can rotate the rotatable portion 164 of the potentiometer 163 while the remainder of the potentiometer 163 remains substantially stationary. In another embodiment, the potentiometer 163 may rotate with a rotating portion of the steering apparatus 102, such as the steering shaft 108 or steering wheel 106, while the rotatable portion 164 of the potentiometer 163 is driven by a relative rotational motion arising from the rotatable portion 164 rotating around a stationary portion of the steering apparatus 102, such as the steering column 110 or the bulkhead 112.

In an embodiment where the transducer 162 may be coupled to a member that is stationary with respect to a rotating motion of the steering apparatus 102, such as the steering column 110 or the bulkhead 112, the transducer 162 can be mechanically coupled to the stationary portion with, for example, interlocking mechanical parts that can include threaded fittings, pressure fittings, friction fittings, rivets, screws and nuts, or some other interlocking mechanical parts; bands or belts that encompass the transducer 162 and the stationary portion; adhesives; some combination of the aforementioned; or some other coupling that can mate the transducer 162 to another structure. In other embodiments, a portion of the transducer 162 may be made integrally with a portion of the steering apparatus 102, such as the steering column 110, or the bulkhead 112.

In the embodiment shown, a substantially u-shaped member 166 is disposed around the steering column 110 such that the steering column 110 is between the extending arms 168, 170 (best shown in FIG. 7) of the u-shaped member 166. Although described and shown as u-shaped, the u-shaped member 166 can also be c-shaped, shaped as an open polygon, a band or belt that partially surrounds a circumference of the steering column 110, or the like. A clamping member 172 is mated to the u-shaped member 166 near the distal ends of the extending arms 168, 170. The clamping member 172 includes apertures 174 through which the extending arms 168, 170 of the u-shaped member 166 can project. Also, the clamping member 172 can have a cut out portion 176 that is shaped to mate with the steering column 110. In the depicted embodiment, because the steering column 110 has a generally circular outermost circumference, the cut out portion 176 has a substantially semi-circular shape that mates with a portion of the outermost circumference of the steering column 110.

The extending arms 168, 170 of the u-shaped member 166 can have threads 178 so that nuts 180 can be threaded onto the extending arms 168, 170 and couple the u-shaped member 166 and the clamping member 172 to the steering column 110.

The transducer 162 can have bores 182 that receive the extending arms 168, 170 of the u-shaped member 166. Second nuts 184 can be threaded onto the extending arms 168, 170 and couple the transducer 162 to the clamping member 172 that may be mated with the u-shaped member 166, thereby coupling the transducer 162 to the steering column 110, i.e., the stationary portion of the steering apparatus 102. In another embodiment, the transducer 162 can be mated to the bulkhead 112 that is stationary with respect to the steering wheel 106 and the steering shaft 108. In yet another embodiment, the clamping member 172 and the transducer 162 can be integrally formed.

Also, elastic members 186 can be placed on the extending arms 168, 170 between the transducer 162 and the second nuts 184. Thus, the transducer 162 can be elastically urged towards the steering shaft 108 so that a portion of the transducer 162, such as the rotatable portion 164, can be driven by the steering shaft 108. The elastic members 186 allow the transducer 162 to maintain contact with the circumference of the steering shaft 108 even if the circumference is not perfectly circular, if debris falls between the transducer 162 and the steering shaft 108, or if a jarring motion of the vehicle 104 or shock pulls the transducer 162 away from the steering shaft 108. In the embodiment shown, the elastic members 186 are coil springs. The second nuts 184 can be adjusted towards or away from the coil springs to adjust the tension of each coil spring.

Furthermore, a first wheel 188 may be disposed at a portion of the steering apparatus 102 for better contact between that portion of the steering apparatus 102 and a portion of the transducer 162, such as the rotatable portion 164 of a potentiometer 163. A second wheel can also be placed on a portion of the transducer 162, such as the rotatable portion 164 of a potentiometer 163, to provide better contact with either the first wheel 188 or another portion of the steering apparatus 102. The first wheel 188 is disposed substantially around a component of the steering apparatus 102, such as an outer circumference of the steering shaft 108. The first wheel 188 can have an opening 190 that is shaped generally similar to the outer circumference of the rotating portion of the steering apparatus 102. The first wheel 188 can also have a substantially circular outer circumference for better and smoother contact with a portion of the transducer 162, such as the rotatable portion 164 of the potentiometer 163. The first wheel 188 can also amplify the rotational motion of a portion of the steering apparatus 102. For example, in embodiments where the first wheel 188 is placed on the steering shaft 108, the outer circumference of the steering shaft 108 is increased to the outer circumference of the first wheel 188 where the first wheel 188 is placed. The first wheel 188 can have a predetermined diameter that is calculated to rotate at a particular or desired ratio. For example, the first wheel 188 may have a diameter such that the rotatable portion 164 of a potentiometer 163 rotates substantially the same number of turns as the steering wheel 106 or the steering shaft 108 when the steering wheel 106 is fully rotated to the right or to the left.

If the portion of the steering apparatus 102, which the first wheel 188 substantially surrounds, is not generally circular, then the opening 190 of the first wheel 188 can have a shape that matches the portion but have a generally circular outer circumference, thereby providing a substantially circular outer circumference where the first wheel 188 is placed. The first wheel 188 can also have an outer circumferential surface 192 that enhances friction between the first wheel 188 and the transducer 162.

The second wheel 194 can be coupled to a portion of the transducer 162, such as the rotatable portion 164 of a potentiometer 163. The second wheel 194 can have a substantially circular outer circumference for better and smoother contact with the first wheel 188, the steering shaft 108, or some other portion of the steering apparatus 102. The second wheel 194 can have an outer circumferential surface 196 that enhances friction between the second wheel 194 and the first wheel 188, the steering shaft 108, or some other portion of the steering apparatus 102. In embodiments where the transducer 162 is a potentiometer 163, the potentiometer 163 provides little resistance to rotational motion, and thus minimal friction is required to move the rotatable portion 164 of the potentiometer 163. The outer circumferential surface 196 can also provide a wear surface that wears away before other components as the control assembly 160 is used. Furthermore, in embodiments where one or more elastic members 186 are provided between the transducer 162 and the second nuts 184, the elastic members 186 can elastically urge the second wheel 194 towards the first wheel 188.

In the embodiment shown in FIGS. 6-7, the first wheel 188 is coupled to the steering shaft 108 and can rotate with the steering shaft 108. When the first wheel 188 rotates, the first wheel 188 rotates a second wheel 194 that is coupled to the rotatable portion 164 of the potentiometer 163. The first wheel 188 can include two generally c-shaped members 198 and 200 that are each placed around a portion of an outer circumference of the steering shaft 108. In other embodiments, there may be more than two c-shaped members 198 or 200 or the c-shaped members 198 or 200 can have another shape that substantially surrounds a portion of the outer circumference of the steering shaft 108. The c-shaped members 198 and 200 are then mated to each other. In the embodiment shown, the c-shaped members 198 and 200 have a threaded passageway 202 that can receive a screw 204. In other embodiments, the c-shaped members 198 or 200 can be mated to each other by some other interlocking mechanical parts, bands, adhesives, or some other coupling. Preferably, the c-shaped members 198 and 200 are first loosely mated to each other around the steering shaft 108 so as to allow repositioning with respect to the second wheel 194 or to the transducer 162 before being fixed to the steering shaft 108. Also, as shown in the figures, the second wheel 194 has a channel 206 that can extend substantially through the center of the second wheel 194 and that can receive a rotatable portion 164 of the potentiometer 163. Thus, when the second wheel 194 is rotated, the second wheel 194 can rotate the rotatable portion 164 of the potentiometer 163. The depicted second wheel 194 has an outer circumferential surface 192 that is provided by a rubber tire.

When assembling the control assembly 160 depicted in FIGS. 6-7, the first wheel 188 can be properly aligned with the second wheel 194, and then the transducer 162 can be tightly coupled to the steering column 110 or the bulkhead 112. However, final tightening of second wheel 194 to the first wheel 188 can result in the first wheel 188 being pulled slightly out of round because the tightening pulls the second wheel 194 towards the first wheel 188 and may move or distort the first wheel 188. Therefore, the transducer 162 is preferably elastically urged towards the first wheel 188 and not fixedly placed adjacent the first wheel 188. The elastic members 186 can compensate for over tightening of the mating of the transducer 162 to the first wheel 188.

Also, the lighting system 100 provides relatively simpler alignment. After the steerable platform assembly 120 has been coupled to the vehicle 104, and the rotational position of the steering wheel 106 and hence the position of the steerable tires of the vehicle 104 are ascertained, the transducer 162 can be pulled away from the first wheel 188, and its output can be adjusted to a particular value for that rotational position of the steering wheel 106 or that position of the steerable tires. Thus, the output of the transducer 162 can be adjusted so that its electrical signal is proportional to the rotational position of the steering wheel 106 or the position of the steerable tires. For example, in an embodiment where the transducer 162 is a potentiometer 163, potentiometer 163 can be pulled away from the first wheel 188, and while the potentiometer 163 is free from the first wheel 188, the rotatable portion 164 can be rotated until the output of the potentiometer 163 is at the desired value for a given position of the steering wheel 106 or the steerable tires.

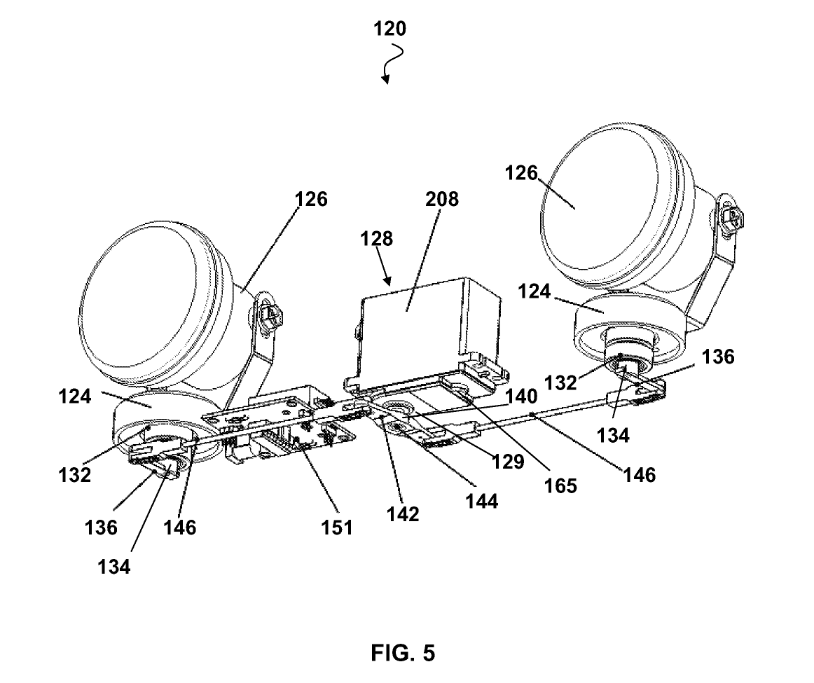

In an exemplary embodiment with a steerable platform assembly 120, as shown in FIGS. 2-5, and a control assembly 160, as shown in FIGS. 6-7, a turn of the steering wheel 106 causes the steering shaft 108 to turn, and the turning of the steering shaft 108 turns the first wheel 188. When the first wheel 188 rotates, the first wheel 188 rotates the second wheel 194, which rotates the rotatable portion 164 of the potentiometer 163, thereby changing the resistance of the potentiometer 163. The potentiometer 163 is substantially fixed to the steering column 110 or bulkhead 112 of the vehicle 104. As the rotatable portion 164 rotates, the potentiometer 163 provides an electrical signal that is generally proportional to the turning of the steering wheel 106. The electrical signal is transmitted to the actuator 128 of the steerable platform assembly 120. In particular, the potentiometer 163 is electrically coupled to a servo driver amplifier (not shown) which amplifies the electrical signal and transmits it to a second potentiometer 165 in the servo housing. The lighting system 100 attempts to generally match the resistance values of the potentiometer 163 and the second potentiometer 165. Thus, power is transmitted to a servo motor 208 (shown in FIG. 5) until the resistances of first and second potentiometers 163, 165 are substantially equalized. As the servo motor 208 moves, it causes the resistance value of the second potentiometer 165 to change and the output shaft 140 to rotate, which rotates the appendage 142 that is fixedly coupled substantially near or at a distal end 144 of the output shaft 140. Because the actuator rod 146 is rotatably coupled to the appendage 142 of the output shaft 140, when the appendage 144 and the output shaft 140 rotate, the actuator rod 146 moves generally towards or away from the steerable platform 124. As the actuator rod 146 moves, the actuator rod 146 causes the arm 136 to rotate, thus rotating the extending member 134, and as the extending member 134 rotates, the steerable platform 124 and the payload 126 mounted to the steerable platform 124 rotate. When the resistance values of the first and second potentiometers 163, 165 are substantially equalized, the servo motor 208 stops and remains in the stopped position, and thus the steerable platform 124 and the payload 126 are stopped at a position which is generally proportional to the rotational position of the steering wheel 106.

Also for the embodiment shown in FIGS. 6-7, if the rotatable portion 164 fails to rotate because of damage, debris, mechanical jamming, or some other cause that substantially prevents the rotatable portion 164 from rotating, the first wheel 188, the steering shaft 108, and steering wheel 106 can still rotate, and thus, the steering apparatus 102 can continue to operate and steer the vehicle 104. The outer circumferential surface 192 of the first wheel 188 can generally slide past the outer circumferential surface 196 of the second wheel 194 because the surfaces 192 and 196 are not interlocked or intermeshed with each other like gears. Also, the elastic member 186 does not elastically urge the second wheel 194 towards the first wheel 188 with such pressure that the first wheel 188 cannot slide past the second wheel 194. Thus, a failure of the control assembly 160 does not cause failure of the steering apparatus 102 of the vehicle 104.

Furthermore, a double pole, double throw relay (not shown) can be electrically coupled between the potentiometer 163 of the control assembly 160 and the servo driver amplifier. The double pole, double throw relay may be energized when the operator of the vehicle 104 selects a reverse gear of the transmission. The double pole, double throw relay exchanges the positive and negative polarities of the potentiometer 163 of the control assembly 160. A second relay (not shown) may also be energized by selecting the reverse gear so that the servo motor rotates in a rotational direction that is opposite to the rotational direction of the steering wheel 106. Thus, the steerable platform 124 will rotate in the opposite rotational direction of the steering wheel 106. In the reverse direction, as the vehicle 104 is steered to the left, the front of the vehicle 104 sweeps to the right. Therefore, when turning the steering wheel 106 to the left while in the reverse direction, lights facing the rear direction should be pointed to the right of the rear direction. When a forward gear of the transmission is selected again, the double pole, double throw relay returns to the original polarity of the potentiometer 163 of the control assembly 160 and de-energizes the second relay.

As apparent from the foregoing description, the lighting system 100 can provide steerable platforms 124 that move proportionally to the steering apparatus 102 of a vehicle 104. The transducer 162 of the control assembly 160 can be easily installed and adjusted for aligning the transducer 162 with the steering apparatus 102 without substantial disassembly. Also, a failure of the control assembly 160 does not impair the steering apparatus 102. Furthermore, the lighting system 100 can be mounted in addition to pre-installed lights.

While a particular embodiment has been chosen to illustrate the invention, it will be understood by those skilled in the art that various changes and modifications can be made therein without departing from the scope of the invention as defined in the appended claims.

What is claimed is:

1. A steerable platform assembly, the assembly comprising:
a body adapted to be mounted to a vehicle;
a platform adapted to receive a payload and adapted to rotate with respect to the body, the platform disposed substantially within the body;
an actuator at least partially disposed in the body; and
an actuator rod rotatably coupled to the actuator and rotatably coupled to the platform, whereby a rotation of the actuator rotates the platform, a length of the actuator rod being adjustable.

2. A steerable platform assembly according to claim 1, wherein the platform further comprises:
a bearing rotatably coupled to the platform and the body;
an extending member that extends from the platform; and
an arm disposed at a distal end of the extending member and rotatably coupled to the actuator rod.

3. A steerable platform assembly according to claim 1, wherein the payload is at least one of a lamp that emits light, a camera, and a countermeasure.

4. A steerable platform assembly according to claim 1, wherein the actuator further comprises:
a servo motor in communication with a first potentiometer; and
a second potentiometer in communication with the servo motor and adapted to provide an electrical signal substantially proportional to a rotational position of the servo motor,
wherein the servo motor rotates until a resistance value of the second potentiometer substantially equals a resistance value of the first potentiometer.

5. A steerable platform assembly according to claim 1, wherein the actuator further comprises:
an output shaft driven by the actuator; and
an appendage coupled to a distal end of the output shaft and rotatably coupled to the actuator rod.

6. A control assembly, the assembly comprising:
a first wheel adapted to be disposed on a rotating portion of a steering apparatus and rotatable with the rotating portion of the steering apparatus;
a transducer adapted to be coupled to a stationary portion of the steering apparatus, the transducer including a rotatable portion;
a second wheel coupled to the rotatable portion and adapted to be rotated by the first wheel; and
an elastic member that elastically urges the transducer and the second wheel towards the first wheel.

7. A control assembly according to claim 6, wherein the first wheel further comprises:
at least one substantially c-shaped member that is adapted to be disposed on a portion of an outer circumference of a steering shaft of the steering apparatus.

8. A control assembly according to claim 6, wherein the first wheel is disposed substantially around a steering shaft and rotates with the steering shaft.

9. A control assembly according to claim 6, wherein the first wheel has a predetermined diameter so that the first wheel rotates at a particular ratio with respect to a steering wheel of the steering apparatus.

10. A control assembly according to claim 6, wherein the transducer includes a potentiometer.

11. A control assembly according to claim 10, further comprising:
a double pole, double throw relay electrically coupled to the potentiometer, the double pole, double throw relay reversing an output polarity of the potentiometer.

12. A control assembly according to claim 10, further comprising a second potentiometer in communication with the potentiometer,
wherein the potentiometer transmits an electrical signal until a resistance value of the second potentiometer substantially equals a resistance value of the potentiometer.

13. A control assembly according to claim 10, further comprising a servo motor in communication with the potentiometer and adapted to rotate proportionally to a rotational position of the potentiometer.

14. A control assembly according to claim 6, wherein the second wheel further comprises a rubber tire that is disposed substantially around an outer circumference of the second wheel.

15. A control assembly according to claim 6, further comprising:
a substantially u-shaped member with at least one extending arm, the substantially u-shaped member being disposed around a part of the stationary portion of the steering apparatus; and
a clamping member with at least one aperture to receive the at least one extending arm, the clamping member coupled to the u-shaped member,
wherein the transducer includes a bore to receive the at least one extending arm and the elastic member is mounted on the at least one extending arm so that the elastic member elastically urges the transducer towards the clamping member.

16. A steerable system, the system comprising:
a steerable platform assembly including,
a body adapted to be mounted to a vehicle,
a platform adapted to receive a payload and adapted to rotate with respect to the body, the platform disposed substantially within the body,
an actuator disposed in the body, and
an actuator rod rotatably coupled to the actuator and rotatably coupled to the platform, whereby a rotation of the actuator rotates the platform, a length of the actuator rod being adjustable; and
a control assembly including,
a first wheel adapted to be disposed on a steering shaft and rotatable with the steering shaft,
a potentiometer with a rotatable portion and adapted to be coupled to a stationary portion of the vehicle, the potentiometer in communication with the actuator,
a second wheel coupled to the rotatable portion and adapted to be rotated by the first wheel; and
an elastic member that elastically urges the potentiometer and the second wheel towards the first wheel,
wherein rotation of a steering wheel causes rotation of the steering shaft, the first wheel, the second wheel, and the rotatable portion of the transducer, and
wherein the rotation of the rotatable portion changes a resistance value of the potentiometer and the actuator rotates in response.

17. A steerable system according to claim 16, wherein the first wheel has a predetermined diameter so that the first wheel rotates at a particular ratio with respect to a steering wheel of the steering apparatus.

18. A steerable system according to claim 16, wherein the actuator further comprises:
a servo motor in communication with the potentiometer; and
a second potentiometer in communication with the servo motor and adapted to provide an electrical signal substantially proportional to a rotational position of the servo motor,
wherein the servo motor rotates until the resistance value of the second potentiometer substantially equals a resistance value of the potentiometer.

19. A steerable system according to claim 16, further comprising:
a double pole, double throw relay electrically coupled to the potentiometer, the double pole, double throw relay reversing an output polarity of the potentiometer.

20. A steerable system according to claim 16, wherein the payload is at least one of a lamp that emits light, a camera, and a countermeasure.
